(19) United States
(12) Patent Application Publication
(10) Pub. No.: US 2024/0347934 A1
(43) Pub. Date: Oct. 17, 2024

(54) TERMINAL-EQUIPPED WIRE AND CONNECTION TERMINAL

(71) Applicant: Yazaki Corporation, Tokyo (JP)

(72) Inventor: Naoki ITO, Shizuoka (JP)

(73) Assignee: Yazaki Corporation, Tokyo (JP)

(21) Appl. No.: 18/626,635

(22) Filed: Apr. 4, 2024

(30) Foreign Application Priority Data
Apr. 17, 2023 (JP) 2023-067035

(51) Int. Cl. H01R 4/18

(52) U.S. Cl. CPC H01R 4/184

(57) ABSTRACT

A terminal-equipped wire includes a wire and a connection terminal. The connection terminal includes: a bottom plate on which the wire is disposed; an electric connection portion which is formed at a front end of the bottom plate and to which another component or the like is connected; a conductor connection portion which is formed at the rear of the bottom plate and to which a conductor of the wire is connected; and a connection portion formed in a portion between the electric connection portion and the conductor connection portion in the bottom plate. The connection portion includes a pair of terminal pieces projecting outward in a width direction from both side edges in the width direction of the bottom plate, and is formed in a state where the pair of terminal pieces are folded inward in the width direction.

### CROSS-REFERENCE TO RELATED APPLICATIONS

The present application is based on, and claims priority from Japanese Patent Application No. 2023-067035, filed on Apr. 17, 2023, the entire contents of which are incorporated herein by reference.

### TECHNICAL FIELD

The present disclosure relates to a terminal-equipped wire and a connection terminal.

### BACKGROUND

A generally-known connection terminal (crimp terminal) crimped and connected to a wire has a conductor connection portion which is crimped to a conductor of the wire exposed at the end of the wire by means of swaging (see JP2021-190241A). The conductor connection portion has, for example, a bottom plate, and plate-like conductor connection pieces which are positioned on both sides of the bottom plate in a direction orthogonal to the extending direction of the wire and extend from the bottom plate. In a state in which the conductor of the wire is disposed on the bottom plate, the conductor connection portion is crimped to the conductor by swaging the conductor connection portion using the conductor connection pieces positioned on both sides of the bottom plate so as to cover the conductor.

### SUMMARY OF THE INVENTION

In the future, it is expected that the cross-sectional area of the conductor of the wire will increase with the increase in the current of a power supply circuit. However, in the connection terminal as described above, if the space between the electric connection portion to which other components are connected and the conductor connection portion has a large distance, there is a possibility that the temperature increases when a large current is applied due to the insufficient cross-sectional area of the terminal.

An object of the present disclosure is to provide a terminal-equipped wire and a connection terminal capable of suppressing an increase in temperature in the terminal portion between the electric connection portion and the conductor connection portion when a large current is applied to the connection terminal.

A terminal-equipped wire according to an embodiment includes a wire and a connection terminal. The connection terminal includes: a plate-like terminal body on which the wire is disposed; an electric connection portion which is formed at a front end of the terminal body and to which another component is connected; a conductor connection portion which is formed at the rear of the terminal body and to which a conductor of the wire is connected; and a connection portion formed in a portion between the electric connection portion and the conductor connection portion in the terminal body, in which the connection portion includes a pair of terminal pieces projecting outward in a width direction from both side edges in the width direction of the terminal body, and is formed in a state where the pair of terminal pieces are folded inward in the width direction.

A connection terminal according to an embodiment includes: a plate-like terminal body on which a wire is disposed; an electric connection portion which is formed at a front end of the terminal body and to which another component is connected; a conductor connection portion which is formed at the rear of the terminal body and to which a conductor of the wire is connected; and a connection portion formed in a portion between the electric connection portion and the conductor connection portion in the terminal body, in which the connection portion includes a pair of terminal pieces projecting outward in a width direction from both side edges in the width direction of the terminal body, and is formed in a state where the pair of terminal pieces are folded inward in the width direction.

The above configuration makes it possible to provide a terminal-equipped wire and a connection terminal capable of suppressing an increase in temperature in the terminal portion between the electric connection portion and the conductor connection portion when a large current is applied to the connection terminal.

### BRIEF DESCRIPTION OF DRAWINGS

FIG. 1 is a plan view illustrating an example of a terminal-equipped wire according to a present embodiment.

FIG. 2 is a side view illustrating an example of the terminal-equipped wire according to the present embodiment.

FIG. 3 is a cross-sectional view taken along A-A line of FIG. 1.

FIG. 4 is a cross-sectional view taken along B-B line of FIG. 1.

FIG. 5 is a perspective view of a connection terminal.

FIG. 6 is a plan view of the connection terminal.

FIG. 7 is a side view of the connection terminal.

FIG. 8 is a developed view of the connection terminal.

FIG. 9 is a cross-sectional view illustrating a crimping step.

FIG. 10 is a plan view illustrating an example of a terminal-equipped wire according to another embodiment.

FIG. 11 is a side view illustrating an example of the terminal-equipped wire according to another embodiment.

FIG. 12 is a cross-sectional view taken along C-C line of FIG. 10.

FIG. 13 is a plan view of a connection terminal.

FIG. 14 is a side view of the connection terminal.

FIG. 15 is a developed view of the connection terminal.

### DETAILED DESCRIPTION OF THE INVENTION

Hereinafter, a terminal-equipped wire according to a present embodiment will be described in detail with reference to the drawings. Note that the dimensional ratio of the drawings is exaggerated for the sake of explanation, and may differ from the actual ratio.

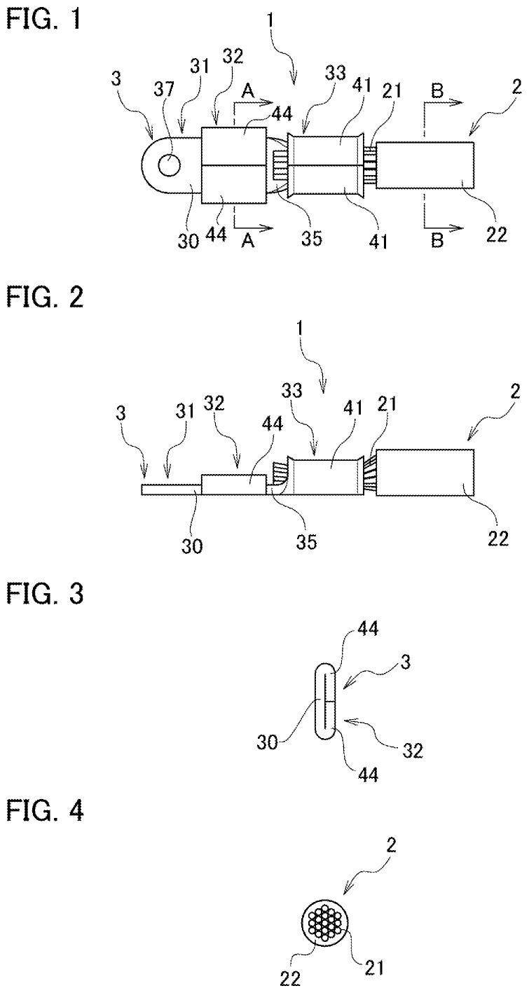

As illustrated in FIGS. 1 to 4, a terminal-equipped wire 1 includes a wire 2 and a connection terminal 3. The connection terminal 3 is a terminal (crimp terminal) crimped and connected to the wire 2. The connection terminal 3 is electrically connected to a mating terminal (not illustrated) or the like in a state in which it is integrally connected to the wire 2. In the wire 2 to which the connection terminal 3 is crimped, an insulator 22 is removed at the end, and a conductor 21 is exposed for a predetermined length. The conductor 21 of the present embodiment is an aggregate of a plurality of elementary wires. The conductor 21 is formed of a conductive metal material such as copper or aluminum, and the insulator 22 is formed of an insulating coating material. The connection terminal 3 is crimped to the end of the wire 2, thereby being electrically connected to the exposed conductor 21.

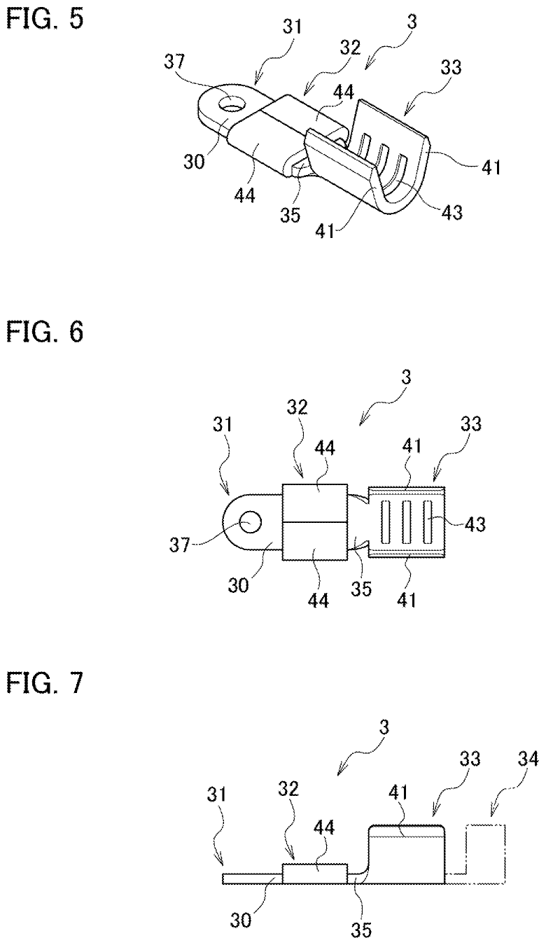

As illustrated in FIGS. 5 to 8, the connection terminal 3 has a bottom plate 30 formed of a metal material (plate-like terminal body). In the bottom plate 30, an electric connection portion 31, a connection portion 32, and a conductor connection portion 33 are formed in the front-rear direction of the connection terminal 3, or from one end side to the other end side in the extending direction of the wire 2 to which the connection terminal 3 is crimped. Further, a joint 35 that joints the space between the connection portion 32 and the conductor connection portion 33 is formed between the connection portion 32 and the conductor connection portion 33.

The electric connection portion 31 is a portion that is connected to a mating terminal, such as another component (not illustrated). The electric connection portion 31 of the present embodiment has a bolt insertion hole 37 formed in the bottom plate 30. However, the configuration of the electric connection portion 31 is not limited thereto. The electric connection portion 31 may have a box portion formed in a box shape, for example.

The conductor connection portion 33 is a portion to be crimped to the conductor 21 of the wire 2 to which the connection terminal 3 is crimped, and the connection portion 32 is a portion to be disposed between the electric connection portion 31 and the conductor connection portion 33. The joint 35 includes the bottom plate 30 positioned between the connection portion 32 and the conductor connection portion 33, in which the bottom plate 30 joints the rear end portion of the connection portion 32 and the front end of the conductor connection portion 33.

That is, at the position of the conductor connection portion 33 of the bottom plate 30, a pair of conductor connection pieces 41 and 41 which are crimped to the conductor 21 of the wire 2 are formed so as to project outward. The pair of conductor connection pieces 41 and 41 extend from both side edges of the bottom plate 30 in a direction intersecting with the extending direction of the wire 2. Before being crimped to the wire 2, the bottom plate 30 and the pair of conductor connection pieces 41 and 41 are formed in a substantially U-shape when viewed from the extending direction of the wire 2 (see FIG. 5). Further, at the position of the conductor connection portion 33 of the bottom plate 30, serrations 43 extending in a groove shape over the bottom plate 30 and the pair of conductor connection pieces 41 and 41 are formed along the direction intersecting with the extending direction of the wire 2. In the present embodiment, three serrations 43 are formed side by side in the extending direction of the wire 2 that is crimped at the conductor connection portion 33.

The conductor connection portion 33 is not limited to the one to be crimped and connected, and for example, the conductor connection portion 33 may be connected by welding such as thermal crimping, or ultrasonic bonding.

The connection terminal 3 may have an insulator connection portion 34 (see FIG. 7) formed in a portion which is rearward of the conductor connection portion 33 in the terminal body (bottom plate 30) and to which the insulator 22 of the wire 2 is connected.

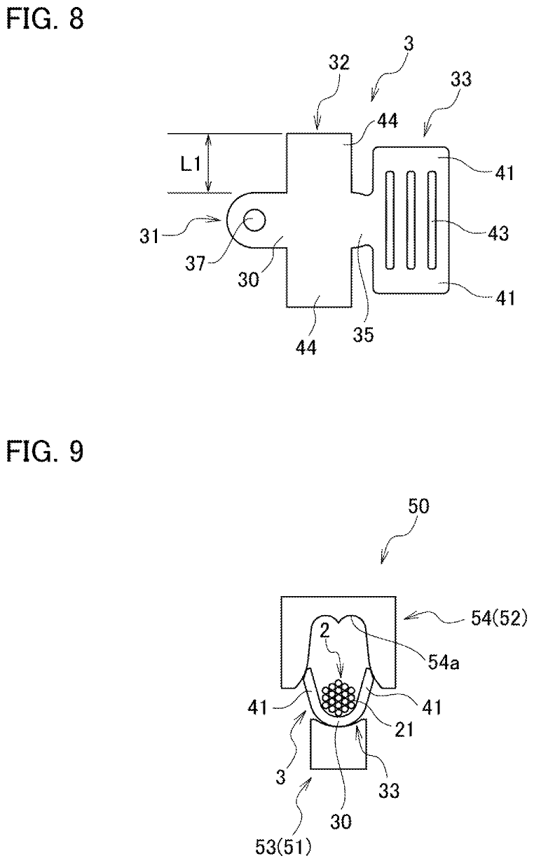

Meanwhile, at the position of the connection portion 32 of the bottom plate 30, a pair of terminal pieces 44 and 44 are formed so as to project outward in the width direction of the bottom plate 30 (see FIG. 8). The pair of terminal pieces 44 and 44 extend from both side edges of the bottom plate 30 in a direction intersecting with the extending direction of the wire 2. The pair of terminal pieces 44 and 44 are folded inward in the width direction of the bottom plate 30 (see FIGS. 5 to 7).

In the present embodiment, the pair of terminal pieces 44 and 44 are bent such that the pair of terminal pieces 44 and 44 come into close contact with each other and the terminal pieces 44 and the bottom plate 30 come into close contact with each other. Specifically, the tip ends of the pair of terminal pieces 44 and 44 constituting the connection portion 32 are opposed to each other, and the tip ends of the pair of terminal pieces 44 and 44 are in contact with each other. Further, the terminal pieces 44 and the bottom plate 30 overlap with each other in a direction intersecting with the front-rear direction of the bottom plate 30, and the inner surface of the terminal pieces 44 and the inner surface of the bottom plate 30 are in contact with each other. The tip ends of the pair of terminal pieces 44 and 44 are abutted against each other at approximately the middle portion in the width direction of the bottom plate 30, and the connection portion 32 has a thickness that is equal to a thickness of 2 sheets of the bottom plate 30 (see FIG. 3).

In the present embodiment, in the connection terminal 3 having a large distance between the electric connection portion 31 and the conductor connection portion 33, the connection portion 32 (a pair of terminal pieces 44 and 44) is formed, and the cross-sectional area of the corresponding portion (see FIG. 3) is set equal to or greater than the cross-sectional area of the conductor 21 of the wire 2 (see FIG. 4). For this reason, the cross-sectional area of the connection portion 32 may be equal to or greater than the cross-sectional area of the conductor 21 of the wire 2.

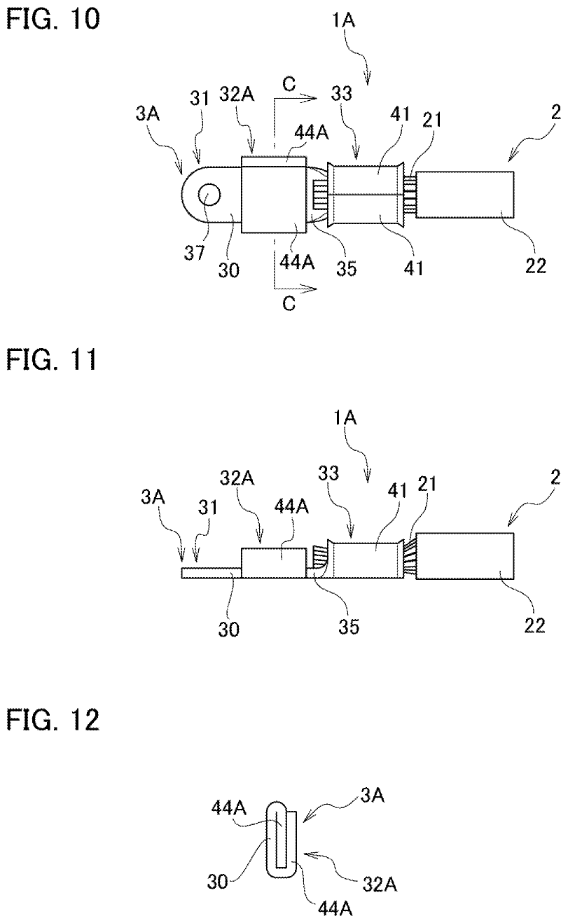

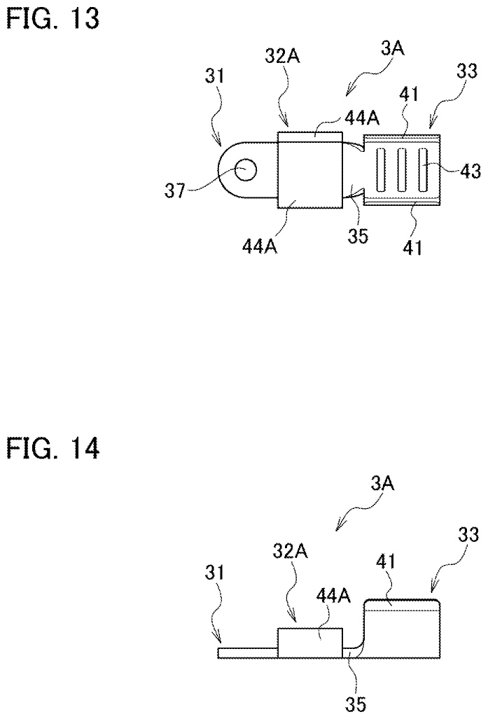

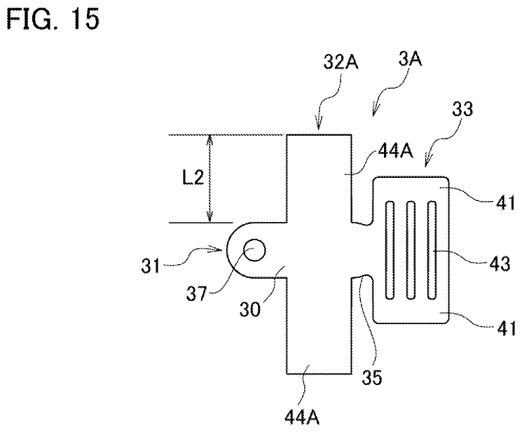

Like a terminal-equipped wire 1A and a connection terminal 3A illustrated in FIGS. 10 to 15, a pair of terminal pieces 44A and 44A constituting a connection portion 32A may overlap with each other in a direction intersecting with the front-rear direction of the bottom plate 30. In the connection terminal 3A, a protrusion length L2 of the terminal piece 44A illustrated in FIG. 15 is set larger than a protrusion length L1 of the terminal piece 44 illustrated in FIG. 8. Further, the pair of terminal pieces 44A and 44A are bent such that the pair of terminal pieces 44A and 44A come into close contact with each other and the terminal pieces 44A and the bottom plate 30 come into close contact with each other. For this reason, in the connection terminal 3A, the connection portion 32A has a thickness that is equal to a thickness of 3 sheets of the bottom plate 30 (see FIG. 12).

Although not illustrated, a gap (space) may be provided between the pair of terminal pieces 44 and 44 constituting the connection portion 32, and a gap (space) may be provided between the terminal pieces 44 and the bottom plate 30. By forming the connection portion 32 in this manner, a space called an air gap is formed between the pair of terminal pieces 44 and 44, and between the terminal pieces 44 and the bottom plate 30, and an air layer existing in the air gap can suppress an increase in temperature of the connection terminal 3.

Hereinafter, an example of a method for manufacturing the terminal-equipped wire 1 will be described.

The method for manufacturing the terminal-equipped wire 1 according to the present embodiment includes at least a disposing step and a crimping step.

First, the disposing step will be described.

The disposing step is a step of disposing the wire 2 in the connection terminal 3. As described above, the wire 2 has the conductor 21, and the insulator 22 for covering the conductor 21 in a state in which the front end of the conductor 21 is exposed. Meanwhile, the connection terminal 3 has the bottom plate 30, and the conductor connection portion 33 which is formed on the bottom plate 30 and to which the exposed conductor 21 is crimped. In the disposing step, the wire 2 is disposed in the connection terminal 3.

In the disposing step, the wire 2 and the connection terminal 3 are disposed in a first mold 51 of a terminal crimp device 50. As illustrated in FIG. 9, the terminal crimp device 50 has the first mold 51 and a second mold 52. The first mold 51 is a fixed mold, and supports the connection terminal 3. The second mold 52 is a movable mold, and moves relatively in the up-down direction with respect to the first mold 51.

As illustrated in FIG. 9, the first mold 51 has an anvil 53. The anvil 53 supports the conductor connection portion 33 of the connection terminal 3.

The second mold 52 has a crimper 54 (wire crimper). The crimper 54 is disposed so as to face the anvil 53. The crimper 54 swages the conductor connection pieces 41, thereby crimping the conductor connection portion 33 to the conductor 21.

In the disposing step, the connection terminal 3 formed in a substantially U-shape is disposed on the upper surface of the first mold 51. The connection terminal 3 is disposed on the upper surface of the first mold 51 such that the conductor connection portion 33 faces the anvil 53 of the first mold 51. More specifically, the connection terminal 3 is disposed such that the bottom plate 30 on which the conductor connection portion 33 is formed is supported by the anvil 53, and such that the tip ends of the pair of conductor connection pieces 41 and 41 are disposed so as to face the crimper 54 of the second mold 52.

The wire 2 is disposed in the connection terminal 3 supported by the first mold 51. The wire 2 is disposed in the connection terminal 3 such that the exposed conductor 21 faces the bottom of the conductor connection portion 33.

Next, the crimping step will be described.

The crimping step is a step of crimping the conductor connection portion 33 of the connection terminal 3 to the conductor 21 of the wire 2. That is, in the crimping step, the conductor connection portion 33 is crimped to the conductor 21. In the crimping step, the wire 2 and the connection terminal 3 are sandwiched between the first mold 51 and the second mold 52. The conductor connection pieces 41 are swaged and crimped to the conductor 21 by the first mold 51 and the second mold 52. In the crimping step, the second mold 52 moves downward toward the first mold 51.

As illustrated in FIG. 9, the crimper 54 has a curved surface 54a that deforms the pair of conductor connection pieces 41 and 41. The conductor connection portion 33 of the present embodiment is crimped to the conductor 21 in a manner called B-crimp. The curved surface 54a deforms the conductor connection pieces 41 into a curved shape such that the tip ends of the pair of conductor connection pieces 41 and 41 are directed to the first mold 51. The crimper 54 deforms the conductor connection pieces 41 such that the conductor 21 is wrapped by the pair of conductor connection pieces 41 and 41 and the bottom plate 30.

Next, the effects of the terminal-equipped wire 1 and the connection terminal 3 will be described.

As described above, the terminal-equipped wire 1 according to an aspect of the present embodiment includes the wire 2 and the connection terminal 3. The connection terminal 3 includes a plate-like terminal body (bottom plate 30) on which the wire 2 is disposed, the electric connection portion 31 which is formed at the front end of the terminal body and to which another component is connected, and the conductor connection portion 33 which is formed at the rear of the terminal body and to which the conductor 21 of the wire 2 is connected. The connection terminal 3 includes the connection portion 32 formed in a portion between the electric connection portion 31 and the conductor connection portion 33 in the terminal body. The connection portion 32 includes the pair of terminal pieces 44 and 44 projecting outward in the width direction from both side edges in the width direction of the terminal body, and is formed in a state where the pair of terminal pieces 44 and 44 are folded inward in the width direction.

In the present embodiment, by increasing the cross-sectional area of the connection portion 32 formed between the electric connection portion 31 and the conductor connection portion 33 as illustrated in the cross-section illustrated in FIG. 3, the specific resistance value of the connection portion 32 is reduced, thereby suppressing the heat generation when a large current is applied. Thus, the current equivalent to the allowable current of the wire 2 can be energized to the connection terminal 3.

As described above, the present embodiment makes it possible to provide the terminal-equipped wire 1 capable of suppressing an increase in temperature in the terminal portion between the electric connection portion 31 and the conductor connection portion 33 when a large current is applied to the connection terminal 3.

In the terminal-equipped wire 1 according to an aspect of the present embodiment, the cross-sectional area of the connection portion 32 may be equal to or greater than the cross-sectional area of the conductor 21 of the wire 2.

In the present embodiment, as in the cross-sectional area illustrated in FIG. 3, the cross-sectional area of the connection portion 32 formed between the electric connection portion 31 and the conductor connection portion 33 is increased such that the cross-sectional area of the connection portion 32 is equal to or greater than the cross-sectional area of the conductor 21 of the wire 2 illustrated in FIG. 4. Since the connection portion 32 is structured in this manner, it is possible to reduce the specific resistance value of the connection portion 32, thereby suppressing the heat generation when a large current is applied. Thus, the current equivalent to the allowable current of the wire 2 can be energized to the connection terminal 3.

In the terminal-equipped wire 1 according to an aspect of the present embodiment, the tip ends of the pair of terminal pieces 44 and 44 constituting the connection portion 32 may face each other.

Since the connection portion 32 is structured in this manner, it is possible to increase the cross-sectional area of the connection portion 32 formed between the electric connection portion 31 and the conductor connection portion 33. Thus, the cross-sectional area of the connection portion 32 can be equal to or greater than the cross-sectional area of the conductor 21 of the wire 2 illustrated in FIG. 4.

In the terminal-equipped wire 1A according to an aspect of another embodiment, the pair of terminal pieces 44 and 44 constituting the connection portion 32A may overlap with each other in the direction intersecting the front-rear direction of the terminal body (bottom plate 30).

Since the connection portion 32A is structured in this manner, it is possible to increase the cross-sectional area of the connection portion 32 formed between the electric connection portion 31 and the conductor connection portion 33. Thus, the cross-sectional area of the connection portion 32A can be equal to or greater than the cross-sectional area of the conductor 21 of the wire 2 illustrated in FIG. 4.

In the terminal-equipped wire 1 according to an aspect of the present embodiment, the pair of terminal pieces 44 and 44 constituting the connection portion 32 may be in contact with each other.

Since the connection portion 32 is structured in this manner, it is possible to increase the cross-sectional area of the connection portion 32 formed between the electric connection portion 31 and the conductor connection portion 33. Thus, the cross-sectional area of the connection portion 32 can be equal to or greater than the cross-sectional area of the conductor 21 of the wire 2 illustrated in FIG. 4.

In the terminal-equipped wire 1, a gap may be provided between the pair of terminal pieces 44 and 44 constituting the connection portion 32.

Since the connection portion 32 is structured in this manner, a space called an air gap is formed between the pair of terminal pieces 44 and 44, and an air layer existing in the air gap can suppress an increase in temperature of the connection terminal 3.

In the terminal-equipped wire 1 according to an aspect of the present embodiment, the connection terminal 3 may have an insulator connection portion 34 (see FIG. 7) formed in a portion which is rearward of the conductor connection portion 33 in the terminal body (bottom plate 30) and to which the insulator 22 covering the conductor 21 of the wire 2 is connected.

Since the connection terminal 3 is structured in this manner, it is possible to enhance the property for holding the wire 2 using the connection terminal 3.

The connection terminal 3 according to an aspect of the present embodiment includes a plate-like terminal body (bottom plate 30) on which the wire 2 is disposed, the electric connection portion 31 which is formed at the front end of the terminal body and to which another component is connected, and the conductor connection portion 33 which is formed at the rear of the terminal body and to which the conductor 21 of the wire 2 is connected. The connection terminal 3 includes the connection portion 32 formed in a portion between the electric connection portion 31 and the conductor connection portion 33 in the terminal body. The connection portion 32 includes the pair of terminal pieces 44 and 44 projecting outward in the width direction from both side edges in the width direction of the terminal body, and is formed in a state where the pair of terminal pieces 44 and 44 are folded inward in the width direction.

In the present embodiment, by increasing the cross-sectional area of the connection portion 32 formed between the electric connection portion 31 and the conductor connection portion 33 as illustrated in the cross-section illustrated in FIG. 3, the specific resistance value of the connection portion 32 is reduced, thereby suppressing the heat generation when a large current is applied. Thus, the current equivalent to the allowable current of the wire 2 can be energized to the connection terminal 3.

As described above, the present embodiment makes it possible to provide the connection terminal 3 capable of suppressing an increase in temperature in the terminal portion between the electric connection portion 31 and the conductor connection portion 33 when a large current is applied to the connection terminal 3.

In the connection terminal 3 according to an aspect of the present embodiment, the cross-sectional area of the connection portion 32 may be equal to or greater than the cross-sectional area of the conductor 21 of the wire 2.

In the present embodiment, as in the cross-sectional area illustrated in FIG. 3, the cross-sectional area of the connection portion 32 formed between the electric connection portion 31 and the conductor connection portion 33 is increased such that the cross-sectional area of the connection portion 32 is equal to or greater than the cross-sectional area of the conductor 21 of the wire 2 illustrated in FIG. 4. Since the connection portion 32 is structured in this manner, it is possible to reduce the specific resistance value of the connection portion 32, thereby suppressing the heat generation when a large current is applied. Thus, the current equivalent to the allowable current of the wire 2 can be energized to the connection terminal 3.

The connection terminal 3 according to an aspect of the present embodiment may be provided with an insulator connection portion 34 (see FIG. 7) formed in a portion which is rearward of the conductor connection portion 33 in the terminal body (bottom plate 30) and to which the insulator 22 covering the conductor 21 of the wire 2 is connected.

Since the connection terminal 3 is structured in this manner, it is possible to enhance the property for holding the wire 2 using the connection terminal 3.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A terminal-equipped wire including a wire and a connection terminal,
the connection terminal includes:
a plate-like terminal body on which the wire is disposed;
an electric connection portion which is formed at a front end of the terminal body and to which another component is connected;
a conductor connection portion which is formed at the rear of the terminal body and to which a conductor of the wire is connected; and
a connection portion formed in a portion between the electric connection portion and the conductor connection portion in the terminal body,
wherein the connection portion includes a pair of terminal pieces projecting outward in a width direction from both side edges in the width direction of the terminal body, and is formed in a state where the pair of terminal pieces are folded inward in the width direction.

2. The terminal-equipped wire according to claim 1,
wherein a cross-sectional area of the connection portion is equal to or greater than a cross-sectional area of the conductor of the wire.

3. The terminal-equipped wire according to claim 1,
wherein tip ends of the pair of terminal pieces constituting the connection portion face each other.

4. The terminal-equipped wire according to claim 1,
wherein the pair of terminal pieces constituting the connection portion overlap with each other in a direction intersecting a front-rear direction of the terminal body.

5. The terminal-equipped wire according to claim 1,
wherein the pair of terminal pieces constituting the connection portion are in contact with each other.

6. The terminal-equipped wire according to claim 1,
wherein a gap is provided between the pair of terminal pieces constituting the connection portion.

7. The terminal-equipped wire according to claim 1,
wherein the connection terminal has an insulator connection portion formed in a portion which is rearward of the conductor connection portion in the terminal body and to which an insulator covering the conductor of the wire is connected.

8. A connection terminal comprising:
a plate-like terminal body on which a wire is disposed;
an electric connection portion which is formed at a front end of the terminal body and to which another component is connected;
a conductor connection portion which is formed at the rear of the terminal body and to which a conductor of the wire is connected; and
a connection portion formed in a portion between the electric connection portion and the conductor connection portion in the terminal body,
wherein the connection portion includes a pair of terminal pieces projecting outward in a width direction from both side edges in the width direction of the terminal body, and is formed in a state where the pair of terminal pieces are folded inward in the width direction.

9. The connection terminal according to claim 8,
wherein a cross-sectional area of the connection portion is equal to or greater than a cross-sectional area of the conductor of the wire.

10. The connection terminal according to claim 8,
wherein the connection terminal has an insulator connection portion formed in a portion which is rearward of the conductor connection portion in the terminal body and to which an insulator covering the conductor of the wire is connected.
